(19) United States
(12) Patent Application Publication
(10) Pub. No.: US 2026/0003825 A1
(43) Pub. Date: Jan. 1, 2026

(54) TECHNIQUES FOR DETECTING FILE SIMILARITY

(71) Applicant: CrowdStrike, Inc., Sunnyvale, CA (US)

(72) Inventors: James Clark, Elk River, MN (US); Michael Slawinski, Rancho Santa Margarita, CA (US)

(21) Appl. No.: 18/756,540

(22) Filed: Jun. 27, 2024

(51) Int. Cl. G06F 16/14; G06N 20/00

(52) U.S. Cl. CPC G06F 16/148; G06N 20/00

(57) ABSTRACT

Techniques for detecting file similarity based on the characteristics and semantics of files are disclosed. A machine learning (ML) model may be trained to recognize and group files based on a hierarchy of file characteristics. The trained ML model may be used to process a set of files to generate a feature vector database comprising a set of feature vectors that are grouped based on the hierarchy of characteristics. In response to receiving a query file to be compared to the set of files, the ML model may be used to process the query file to generate a query feature vector. The query feature vector may be used to search the feature vector database to identify feature vectors that are similar to the query feature vector. A file corresponding to each feature vector that is similar to the query feature vector may be retrieved and presented to a user.

### TECHNICAL FIELD

Aspects of the present disclosure relate to detecting file similarity, and more particularly, to detecting file similarity based on the file characteristics and semantics of files.

### BACKGROUND

The ability to determine whether a particular file is similar to other files may be helpful in a variety of different contexts including detecting sensitive data and combatting malware, among other contexts. With respect to detecting sensitive data, it may be useful to detect whether information contained within a file is of a particular type by comparing the file to files of that particular type to determine whether the file may justify sensitive handling and/or additional protections (e.g., in the case of personal information). For example, a file may be determined to contain personal information, such as health information, based on a similarity to other files known to contain personal information. In response to the determination, the file may be treated differently than other types of files. For example, files containing health information may be marked for additional scrutiny for read/write access and/or may be encrypted.

Similarly, malware may be detected in a file by comparing the contents of the file to known malware. Malware is a term that refers to malicious software. Malware includes software that is designed with malicious intent to cause intentional harm and/or bypass security measures. Malware is used, for example, by cyber attackers to disrupt computer operations, to access and to steal sensitive information stored on the computer or provided to the computer by a user, or to perform other actions that are harmful to the computer and/or to the user of the computer.

Malware may be formatted as executable files (e.g., COM or EXE files), dynamic link libraries (DLLs), scripts, steganographic encodings within media files such as images, and/or other types of computer programs, or combinations thereof. To protect from such malware, users may install scanning programs which attempt to detect the presence of malware and/or protect sensitive files from malware. These scanning programs may review programs and/or executables that exist on the computer's storage medium (e.g., a hard disk drive (HDD)) prior to execution of the file. An incoming file that is similar to a file known to contain malware may be subject to further scanning or remediation. Thus, the ability to detect a similarity between a first file and another file may be useful in detecting malware and/or protecting against malware.

Artificial intelligence (AI) is a field of computer science that encompasses the development of systems capable of performing tasks that typically require human intelligence. Machine learning is a branch of artificial intelligence focused on developing algorithms and models that allow computers to learn from data and make predictions or decisions without being explicitly programmed. Machine learning (ML) models are the foundational building blocks of machine learning, representing mathematical and computational frameworks used to extract patterns and insights from data. Large language models, a category within machine learning models, are trained on vast amounts of text data to capture the nuances of language and context. ML models include machine learning models, large language models, and other types of models that are based on neural networks, genetic algorithms, expert systems, Bayesian networks, reinforcement learning, decision trees, or combination thereof.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

FIG. 1 is a block diagram that illustrates an example system for detecting file similarity, according to some embodiments of the present disclosure.

FIG. 2A is a block diagram illustrating one step of a training process for training a machine learning model, in accordance with some embodiments of the present disclosure.

FIG. 2B is a diagram illustrating different iterations of a file grouping process taking place during the training process illustrated in FIG. 2A, in accordance with some embodiments of the present disclosure.

FIG. 3 is a block diagram illustrating generation of a vector database based on the set of PE files 130 using the machine learning model trained as illustrated in FIGS. 2A and 2B, in accordance with some embodiments of the present disclosure.

FIG. 4 is a block diagram illustrating a search of the vector database illustrated in FIG. 3 using a query feature vector, in accordance with some embodiments of the present disclosure.

FIG. 5 is a flow diagram of a method for determining a similarity between a target file and a set of compare files, in accordance with some embodiments of the present disclosure.

FIG. 6 is a block diagram of an example computing device that may perform one or more of the operations described herein, in accordance with embodiments of the disclosure.

### DETAILED DESCRIPTION

Current approaches to detecting file similarity suffer from several drawbacks. For example, many file similarity detection methods are reliant on feature extraction engines, which can be prone to engineering errors and bugs. In addition, many file similarity detection models are not optimized to identify similar files, but instead are byproducts of machine learning models created for classification and other purposes. For example, some similarity detection methods utilize a model which is optimized solely for separating files based on whether they are clean (i.e., do not correspond to malware) or dirty (i.e., do correspond to malware). However, utilizing such models can cause problems when analyzing similarity between files that are semantically similar but differ with respect to e.g., section names or additions to the overlay of the file. Many current file similarity detection methods are also inefficient in terms of both storage and search speed because they require a database to store large vectors (e.g., 1800 int16 values) for each file.

These methods also require a similarity computation across the entire corpus to find those files having the highest similarity.

The present disclosure addresses the above-noted and other deficiencies by providing a file similarity detection method that generates, using a corpus of existing files, a feature vector database using an artificial intelligence (AI) model that is specifically trained to recognize and group files based on file characteristics. Query files can be compared to the feature vector database to identify files from the corpus of files that are similar to the query files.

The ML model may be trained to iteratively group files based on a hierarchy of file characteristics using a loss function that incorporates a hierarchical loss component as well as a focal loss component. Example file characteristics may include threat type, malware family, subtype (e.g., exe, dll), compiler, packer, and library. The trained ML model may then be used to process a set of files to generate a feature vector database comprising a set of feature vectors, wherein each of the set of feature vectors corresponds to a particular file of the set of files and wherein the set of feature vectors is grouped based on the hierarchy of characteristics. In response to receiving a query file to be compared to the set of files, the ML model may be used to process the query file to generate a query feature vector. The query feature vector may be used to search the feature vector database to identify one or more of the set of feature vectors that are most similar to the query feature vector. A file corresponding to each feature vector that is similar to the query feature vector may be retrieved and presented to a user. As used herein, the term “database” is not limited to a relational database structure or any particular database structure, and may refer to any data storage mechanism that is structured to facilitate the storage, retrieval, modification, and/or deletion of data in conjunction with various data-processing operations.

Embodiments of the present disclosure do not require feature extraction engines and are optimized specifically to generate an embedding space where files that are similar (based on file characteristics) are close together and files that are dissimilar are far apart. The embodiments of the present disclosure also significantly reduce the amount of space required to implement similarity detection techniques and can significantly speed up the search time in comparison to current similarity detection techniques. This is because they do not need to search an entire corpus to find similar files, but instead can reduce the search space down significantly using an appropriate search algorithm.

Though the file similarity detection techniques of the present disclosure are described in the context of malware identification/detection, the embodiments of the present disclosure are not limited to such a scenario. The embodiments of the present disclosure may be useful in other environments in which it may be useful to identify similarities between files. For example, identifying similarities in files may be useful in storage deduplication, file cataloging, file indexing, and the like. Other usage scenarios are also contemplated.

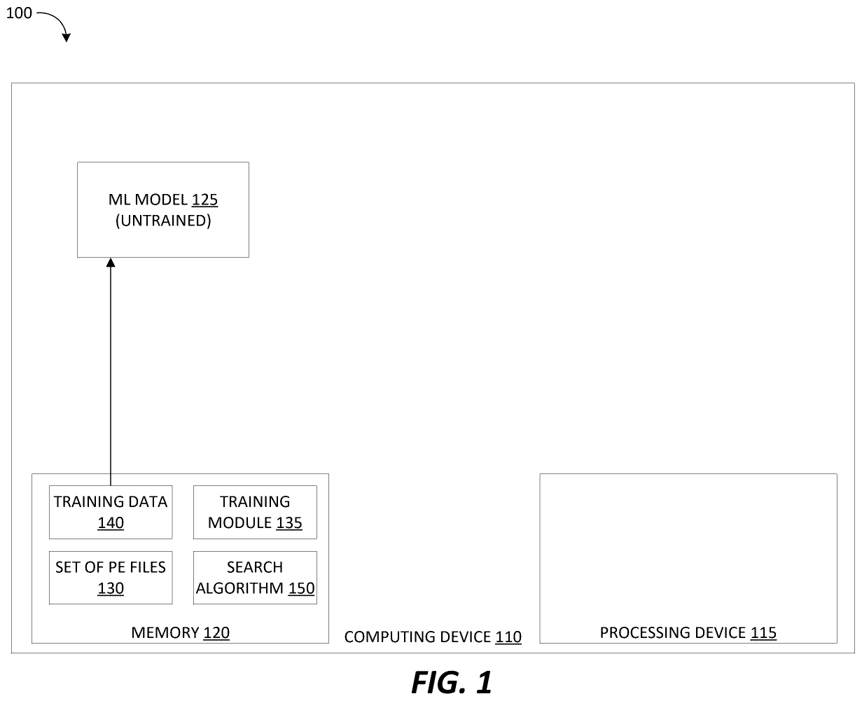

FIG. 1 is a block diagram that illustrates an example system 100 for detecting file similarity, according to some embodiments of the present disclosure. FIG. 1 and the other figures may use like reference numerals to identify like elements. A letter after a reference numeral, such as “105A,” indicates that the text refers specifically to the element having that particular reference numeral. A reference numeral in the text without a following letter, such as “105,” refers to any or all of the elements in the figures bearing that reference numeral.

As illustrated in FIG. 1, the system 100 includes a computing device 110. The computing device 110 may include hardware such as processing device 115 (e.g., processors, central processing units (CPUs)), memory 120 (e.g., random access memory (RAM), storage devices (e.g., hard-disk drive (HDD)), and solid-state drives (SSD), etc.), and other hardware devices (e.g., sound card, video card, etc.).

Processing device 115 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 115 may also comprise one or more special-purpose processing devices such as an application specific integrated circuit (ASIC), a field programmable gate array (FPGA), a graphics processing unit (GPU), a digital signal processor (DSP), network processor, or the like.

Memory 120 may include volatile memory devices (e.g., random access memory (RAM)), non-volatile memory devices (e.g., flash memory) and/or other types of memory devices. In certain implementations, memory 120 may be non-uniform access (NUMA), such that memory access time depends on the memory location relative to processing device 115. In some embodiments, memory 120 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 120 may be configured for long-term storage of data and may retain data between power on/off cycles of the computing device 110.

The computing device 110 may comprise any suitable type of computing device or machine that has a programmable processor including, for example, server computers, desktop computers, laptop computers, tablet computers, smartphones, set-top boxes, etc. In some examples, the computing device 110 may comprise a single machine or may include multiple interconnected machines (e.g., multiple servers configured in a cluster). The computing device 110 may be implemented by a common entity/organization or may be implemented by different entities/organizations.

The memory 120 may include a set of portable executable (PE) files 130. PE files may be files that are in the PE format, which is a file format for executables, object code, DLLs and other file types used in various different environments. The PE format is a data structure that encapsulates the information necessary for an operating system loader to manage the wrapped executable code therein. This includes dynamic library references for linking, API export and import tables, resource management data, and thread-local storage (TLS) data, for example.

Although illustrated as being stored within the memory 120, this is not a limitation and the set of PE files 130 may be stored in its own memory/storage device separate from the memory 120.

Although the file similarity detection techniques of the present disclosure are described in the context of PE files, the embodiments of the present disclosure are not limited to such a scenario. The embodiments of the present disclosure may be used to identify similarities between files of any appropriate type/format.

The memory 120 may also include logic corresponding to an artificial intelligence (AI) model 125 which may be executed by the processing device 115 to perform some of the file similarity detection functions described herein. An ML model may be trained to perform a function(s) using training data and then the trained ML model may be used to make predictions on new data. The process of training an ML model can be seen as a learning process where the ML model is exposed to new, unfamiliar data step by step. At each step, the ML model makes predictions and gets feedback about how accurate its generated predictions were. Once trained, the ML model can be deployed to perform the function it was trained to perform. The ML model 125 may comprise any appropriate deep neural network (DNN) such as a recurrent neural network, a convolutional neural network or a transformer. DNNs utilize neural networks with representation learning, and often employ multiple layers in their network. DNN learning methods can be either supervised, semi-supervised or unsupervised.

The memory 120 may also include a training module 135 that includes logic for training the ML model 125 as discussed in further detail herein. The processing device 115 may execute the training module 135 to train the ML model 125 (using the training data 140) to generate an embedding space where similar files are grouped together in an iterative manner based on a hierarchy of file characteristics, as discussed in further detail herein. The training data 140 may include a set of PE files that each correspond to malicious software (e.g., adware), with no PE files that are “clean” (i.e., do not correspond to malicious software). This is because the goal of the training is to optimize the embedding space based on file similarity without concern for whether the files are clean or dirty (i.e., do correspond to malicious software). This in turn enables the ML model 125 to learn various file characteristics of PE files so that it can group them based on such file characteristics. The file characteristics may be organized in a hierarchy as follows: threat type, malware family, subtype (e.g., exe, dll), compiler, packer, and library. Each PE file of the training data 140 may have a label indicating a value for each of the above file characteristics. It should be noted that the above list of file characteristics as well as their ordering/hierarchy is for example purposes only and the embodiments of the present disclosure are not limited to the above-listed file characteristics. Different and/or additional file characteristics may be used which may also alter the above hierarchy.

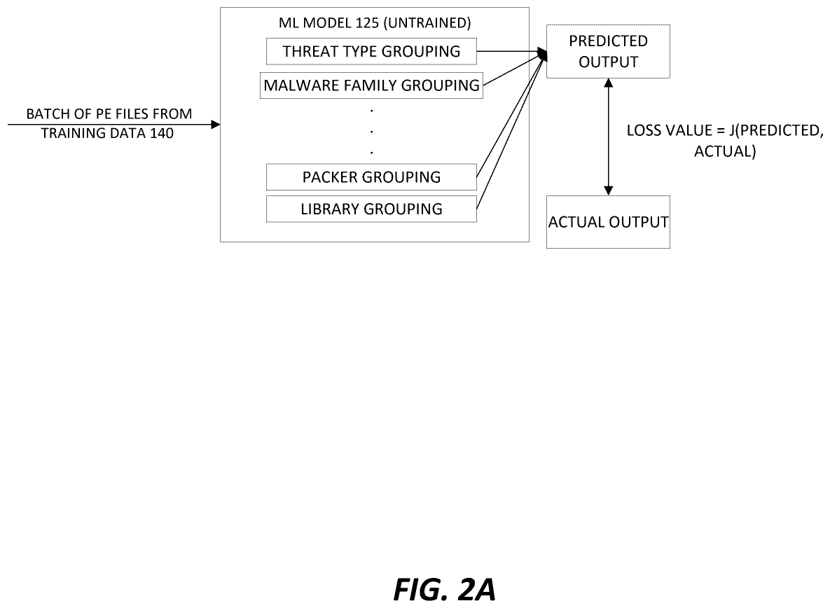

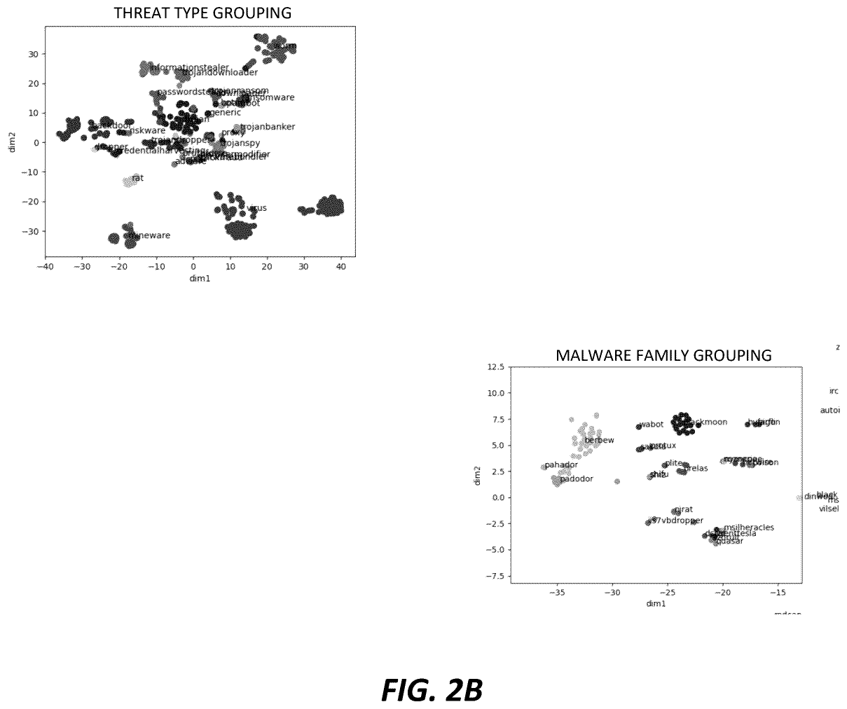

The training module 135 may train the ML model 125 over a series of steps, where at each step of the training process, the ML model 125 may be fed a batch of the PE files from the training data 140. FIG. 2A illustrates one step of the training process for the ML model 125. The ML model 125 may be fed a first batch of the PE files from the training data 140 and may generate a feature vector for each of the PE files in the first batch. The ML model 125 may then iteratively group the feature vectors of the PE files from the first batch based on the above hierarchy of file characteristics such that PE files that are increasingly similar (i.e., share more and more file characteristics) are grouped increasingly closer. For example, at the first iteration the ML model 125 may group the feature vectors of the PE files based on threat type (since threat type is at the top of the hierarchy as discussed above) as shown in FIG. 2B. At the second iteration, for each threat type group of feature vectors, the ML model 125 may further group the PE files therein based on their malware family classification as shown in FIG. 2B. As can be seen in FIG. 2B, the PE files in each malware family group are closer together than the PE files in each threat type group. At the third iteration, for each malware family group of PE files, the ML model 125 may further group the PE files therein based on subtype. The ML model 125 may continue iteratively grouping in this fashion based on the compiler, packer and library file characteristics.

At the end of each iteration (i.e., once the ML model 125 has grouped the PE files based on that iteration's corresponding file characteristic), the training module 135 may analyze each PE files' label for that corresponding file characteristic to ensure that it has been grouped properly, and may use a loss function (denoted as J in FIG. 2A) to apply a penalty to each loss (i.e., incorrect grouping). The loss function determines how accurately (or inaccurately) the ML model 125 is performing by comparing the output (groupings) of the ML model 125 at each iteration with the actual value (based on the file characteristic labels of the training data) the ML model 125 is supposed to output in order to generate a loss value. If the output of the ML model 125 is far from the actual value, the loss value will be high. If the output of the ML model 125 and the actual value are close, the loss value will be low. The training module 135 may measure the distance between the output of the ML model 125 and the actual value using any appropriate measure, such as cosine distance for example. If the cosine distance between the output of the ML model 125 and the actual value is high and the output of the ML model 125 and the actual value have the same label, then the loss is high. If the cosine distance between the actual value and the output of the ML model 125 is high, but the actual value and the output of the ML model 125 have different labels, then the loss will be low. The penalty applied to each incorrect grouping is based on the loss value. If the loss value is low the training module 135 will not modify the weights applied to the ML model 125 significantly, as it is already performing relatively well. As the loss value increases, the training module 135 may increase the amount by which it modifies the weights for the ML model 125. In this way, the ML model 125 learns to push PE files further together or further apart based on their file characteristics.

In the example FIGS. 2A and 2B, at the end of the second iteration the training module 135 may analyze the malware family label for each PE file the ML model 125 has grouped in the “berbew” malware family grouping to ensure that those PE files are in fact in the “berbew” malware family. If the training module 135 determines that any of the PE files in the “berbew” grouping are not part of the “berbew” malware family based on their labels, it may use the loss function to apply the penalty. As the ML model 125 groups the PE files at each iteration, the training module 135 may go through all of the labels in a tree like fashion and continue applying the loss function. By applying the loss function at each iteration, the ML model 125 learns to recognize each different file characteristic of PE files as well as to separate files based on each different file characteristic of PE files as opposed to simply separating files based on whether they are clean or dirty. In this way, the ML model 125 is optimized specifically to generate an embedding space where PE files that are similar are close together and PE files which are dissimilar are far apart.

To train the ML model 125, the training module 135 may utilize a loss function that incorporates both a hierarchical contrastive learning (HCL) loss component and a focal loss (FL) component. The HCL loss component is used to teach the ML model 125 to generate an embedding space where feature vectors corresponding to PE files are separated in a hierarchical fashion such that PE files from the same threat type are close together, then PE files from the same malware family are even closer together, and so on as the ML model 125 continues down the hierarchy of file characteristics. The FL component is used to teach the ML model 125 to focus in on PE files that are hard to fit, as PE file sets are often highly imbalanced (e.g., PE file sets often include more samples from particular malware families than from others). The FL component may comprise a categorical loss function that is a variation of a standard cross-entropy loss function. For each file characteristic, the ML model 125 may have a layer that attempts to classify PE files based on that file characteristic and the FL component may aid the layer corresponding to each file characteristic to focus on PE files that are difficult to group. The loss function (J) incorporates both the HCL loss component and the FL component and weights the HCL loss component with the FL component. The loss function may be given as:

$$J = ( 1 - λ ) * HCL + λ * FL$$

As can be seen, the training module 135 may compute a component-specific loss value for each of the loss components (HCL and FL), and determine the loss value based on the sum of the component-specific loss value.

The training module 135 may train the ML model 125 in this manner over a series of steps, inputting a new batch of PE files from the training data 140 at each step, until the training module 135 determines that the ML model 125 has been trained. For example, the training module 135 may determine that the ML model 125 has been trained when the loss value generated at each iteration of grouping is sufficiently small (based on a predefined threshold, for example). It should be noted that the ML model 125 may be trained on/May operate on raw bytes of PE files and thus does not require a feature extraction engine.

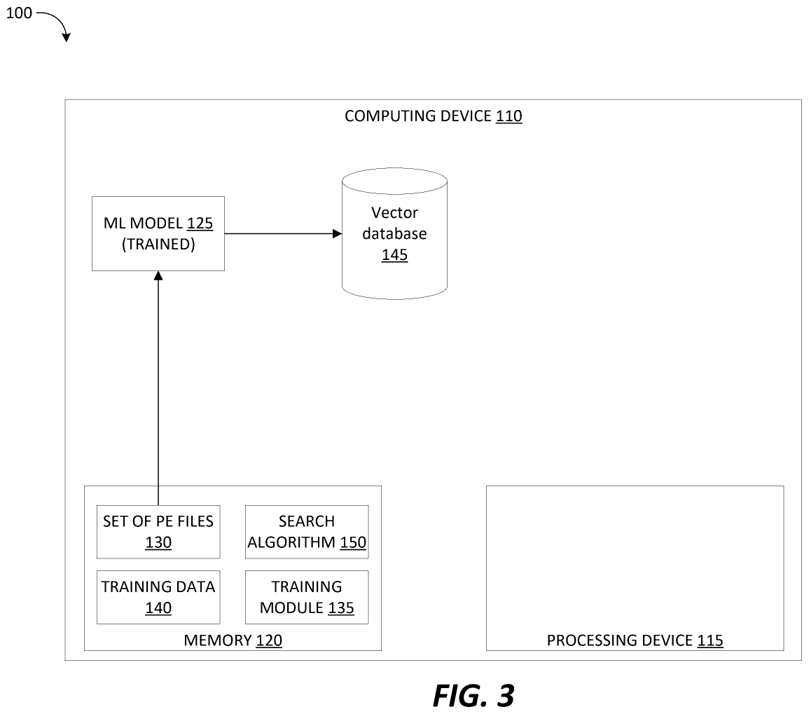

FIG. 3 is a block diagram illustrating generation of a feature vector database 145 based on the set of PE files 130. Once the ML model 125 is trained, the processing device 115 may process the set of PE files 130 using the ML model 125 to generate an embedding space including the feature vector for each of the PE files in the set of PE files 130, where feature vectors that are increasingly similar (i.e., share more and more file characteristics) are grouped increasingly closer together. More specifically, the ML model 125 may generate a feature vector for each of the PE files in the set of PE files 130 resulting in a set of feature vectors. The ML model 125 may iteratively group the set of feature vectors based on the hierarchy of file characteristics as discussed hereinabove to generate the embedding space. The processing device 115 may store the generated embedding space as the feature vector database 145. Although shown in FIG. 3 as stored in a dedicated memory device, this is not a limitation and the generated embedding space may be stored as a feature vector database in the memory 120 as well.

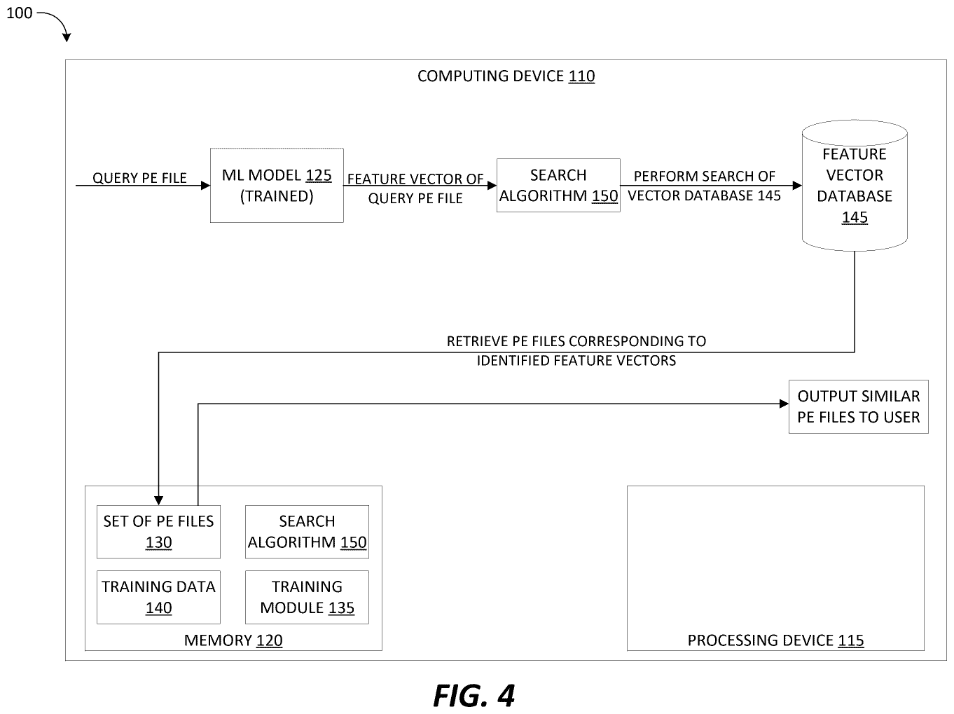

FIG. 4 is a block diagram illustrating the process of determining whether a PE file received from a user is similar to any of the PE files in the set of PE files 130. In response to receiving a PE file from a user (hereinafter referred to as the “query PE file”), the processing device 115 may process the query PE file using the ML model 125 to generate a feature vector of the query PE file. The processing device 115 may execute the search algorithm 150 to query the feature vector database 145 to determine if there are feature vectors in the feature vector database 145 that are similar to the feature vector of the query PE file (i.e., if there are any PE files in the set of PE files 130 that are similar to the query PE file). The search algorithm 150 may comprise any appropriate search algorithm. In some embodiments, the search algorithm 150 may comprise the scalable nearest neighbors (scaNN) algorithm which can perform an approximate nearest neighbors search over the various feature vector groupings in the feature vector database 145 and find nearest neighbors over large numbers of embeddings (e.g., billions) with high recall ability and speed.

The search algorithm 150 may identify a number of feature vectors in the feature vector database 145 that are the most similar to the feature vector of the query PE file. The number of identified feature vectors may be defined in any appropriate way. For example, the number of identified feature vectors may be predefined (e.g., the top three most similar feature vectors). In another example, the number of identified feature vectors may include any feature vectors that satisfy a threshold level of similarity with the feature vector of the query PE file. For each identified feature vector, the processing device 115 may retrieve the corresponding PE file from the set of PE files 130 and present the retrieved PE files to the user.

Embodiments of the present disclosure provide a file similarity detection method that does not require feature extraction engines and are optimized specifically to generate an embedding space where files that are increasingly similar (based on file characteristics) are increasingly closer together and files that are dissimilar are farther apart. In addition, the embodiments of the present disclosure can significantly reduce the amount of space required to implement similarity detection techniques and can significantly speed up the search time in comparison to current similarity detection techniques.

Embodiments of the present disclosure may be applied in a variety of different scenarios. For example, if a user wishes to detect whether a particular PE file(s) (also referred to herein as a target PE file) contains malware, they may generate the feature vector database 145 using a set of PE files corresponding to malware. The user can then provide the particular PE file(s) as the query PE file to the search algorithm 150 which will identify whether the particular PE file is similar to any of the PE files corresponding to malware.

In some embodiments, in response to determining that the target PE file is similar to one or more PE files, the processing device 115 may perform certain remediation actions. A remediation action may refer to an action and/or operation taken in response determining a similarity between the target PE file and any of the PE files in the set of PE files 130 (i.e., a comparison set of files). Remediation actions may include acts such as providing additional protection for the target PE file, enforcing additional restrictions for the target PE file, sensitive and/or secure handling of the target PE file, special flagging and/or identification of the target PE file, quarantining of the target PE file, deletion of the target PE file, alert propagation based on the target PE file, and other operations intended to provide appropriate handling in response to the detected similarity. In some embodiments, the detected similarity may provide information related to a characteristic of the target PE file (e.g., the target PE file is likely to contain personal and/or sensitive information, the target PE file may be similar to malware, etc.) and the remediation operation is an action taken in response to that characteristic of the target PE file (e.g., appropriate handling for personal and/or sensitive information, protection with respect to the potential malware, etc.) The provided examples of remediation actions are not intended to limit the embodiments of the present disclosure. Other types of remediation actions may be utilized without deviation from the scope of the embodiments described herein.

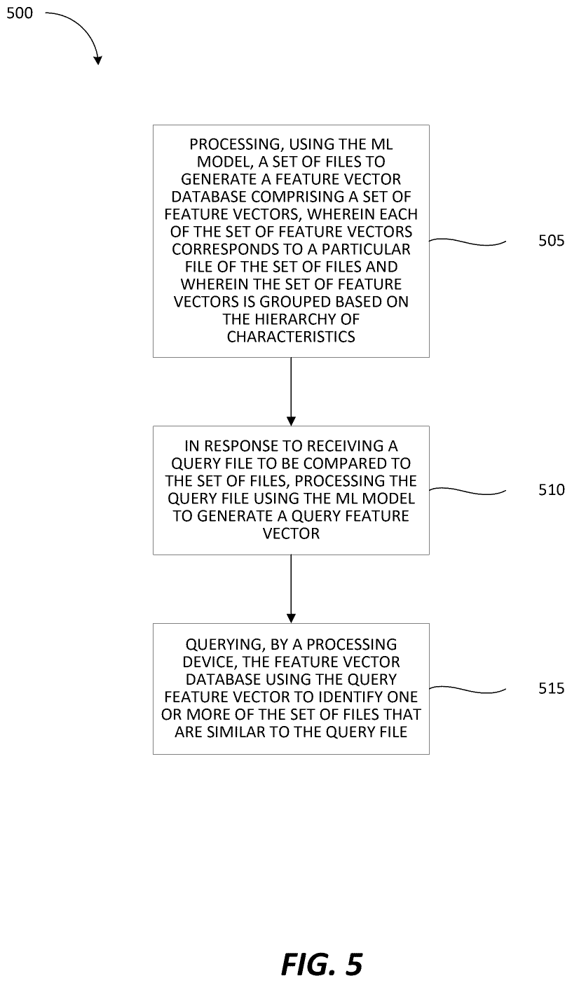

FIG. 5 is a flow diagram of a method 500 for determining a similarity between a target file and a set of PE files 130 (i.e., a comparison set of files), in accordance with some embodiments of the present disclosure. A description of elements of FIG. 5 that have been described previously will be omitted for brevity. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 500 may be performed by a computing device (e.g., computing device 110).

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed.

Referring simultaneously to the FIGS. 1-4 as well, the processing device 115 may execute the training module 135 to train the ML model 125 (using the training data 140) to generate an embedding space where similar files are grouped together in an iterative manner based on a hierarchy of file characteristics, as discussed in further detail herein. The training data 140 may include a set of PE files that each correspond to malicious software (e.g., adware), with no PE files that are “clean” (i.e., do not correspond to malicious software). This is because the goal of the training is to optimize the embedding space based on file similarity without concern for whether the files are clean or dirty (i.e., do correspond to malicious software). This in turn enables the ML model 125 to learn various file characteristics of PE files so that it can group them based on such file characteristics. The file characteristics may be organized in a hierarchy as follows: threat type, malware family, subtype (e.g., exe, dll), compiler, packer, and library. Each PE file of the training data 140 may have a label indicating a value for each of the above file characteristics. It should be noted that the above list of file characteristics as well as their ordering/hierarchy is for example purposes only and the embodiments of the present disclosure are not limited to the above-listed file characteristics. Different and/or additional file characteristics may be used which may also alter the above hierarchy.

At block 505, the processing device 115 may process the set of PE files 130 using the ML model 125 to generate the feature vector database 145. More specifically, once the ML model 125 is trained, the processing device 115 may process the set of PE files 130 using the ML model 125 to generate an embedding space including the feature vector for each of the PE files in the set of PE files 130, where feature vectors that are increasingly similar (i.e., share more and more file characteristics) are grouped increasingly closer together. More specifically, the ML model 125 may generate a feature vector for each of the PE files in the set of PE files 130 resulting in a set of feature vectors. The ML model 125 may iteratively group the set of feature vectors based on the hierarchy of file characteristics as discussed hereinabove. The processing device 115 may store the generated embedding space as the feature vector database 145. Although shown in FIG. 3 as stored in a dedicated memory device, this is not a limitation and the generated embedding space may be stored in the memory 120 as well.

At block 510, in response to receiving a PE file from a user (hereinafter referred to as the “query PE file”), the processing device 115 may process the query PE file using the ML model 125 to generate a feature vector of the query PE file. At block 515, the processing device 115 may execute the search algorithm 150 to query the feature vector database 145 to determine if there are feature vectors in the feature vector database 145 that are similar to the feature vector of the query PE file (i.e., if there are any PE files in the set of PE files 130 that are similar to the query PE file). The search algorithm 150 may comprise any appropriate search algorithm. In some embodiments, the search algorithm 150 may comprise the scalable nearest neighbors (scaNN) algorithm which can perform an approximate nearest neighbors search and find neighbors over large numbers of embeddings (e.g., billions) with high recall ability and speed.

The search algorithm 150 may identify a number of feature vectors in the feature vector database 145 that are the most similar to the feature vector of the query PE file. The number of identified feature vectors may be defined in any appropriate way. For example, the number of identified feature vectors may be predefined (e.g., the top three most similar feature vectors). In another example, the number of identified feature vectors may include any feature vectors that satisfy a threshold level of similarity with the feature vector of the query PE file. For each identified feature vector, the processing device 115 may retrieve the corresponding PE file from the set of PE files 130 and present the retrieved PE files to the user.

In some embodiments, in response to determining that the target PE file is similar to one or more PE files, the processing device 115 may perform certain remediation actions. A remediation action may refer to an action and/or operation taken in response determining a similarity between the target PE file and any of the PE files in the set of PE files 130 (i.e., a comparison set of files). Remediation actions may include acts such as providing additional protection for the target PE file, enforcing additional restrictions for the target PE file, sensitive and/or secure handling of the target PE file, special flagging and/or identification of the target PE file, quarantining of the target PE file, deletion of the target PE file, alert propagation based on the target PE file, and other operations intended to provide appropriate handling in response to the detected similarity. In some embodiments, the detected similarity may provide information related to a characteristic of the target PE file (e.g., the target PE file is likely to contain personal and/or sensitive information, the target PE file may be similar to malware, etc.) and the remediation operation is an action taken in response to that characteristic of the target PE file (e.g., appropriate handling for personal and/or sensitive information, protection with respect to the potential malware, etc.) The provided examples of remediation actions are not intended to limit the embodiments of the present disclosure. Other types of remediation actions may be utilized without deviation from the scope of the embodiments described herein.

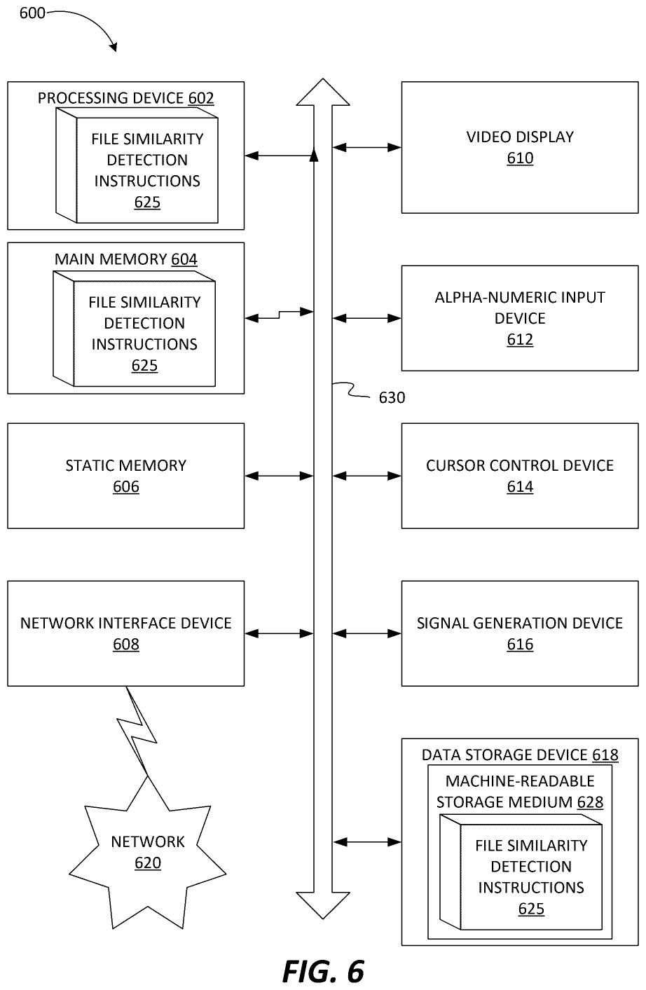

FIG. 6 is a block diagram of an example computing device 600 that may perform one or more of the operations described herein, in accordance with some embodiments of the disclosure. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also include one or more special-purpose processing devices such as an application specific integrated circuit (ASIC), a field programmable gate array (FPGA), a digital signal processor (DSP), a graphics processing unit (GPU), network processor, or the like. The processing device 602 may execute the operations described herein, in accordance with one or more aspects of the present disclosure, for performing the operations and steps discussed herein.

Computing device 600 may further include a network interface device 608 which may communicate with a network 620. The computing device 600 also may include a video display unit 66 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 66, alphanumeric input device 612, and cursor control device 614 may be combined into a single component or device (e.g., an LCD touch screen).

Data storage device 618 may include a computer-readable storage medium 628 on which may be stored one or more sets of file similarity detection instructions 625 that may include instructions for search algorithm 150 for carrying out the operations described herein, in accordance with one or more aspects of the present disclosure. File similarity detection instructions 625 may also reside, completely or at least partially, within main memory 604 and/or within processing device 602 during execution thereof by computing device 600, main memory 604 and processing device 602 also constituting computer-readable media. The file similarity detection instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “training,” “providing,” “processing,” “querying,” “generating,” “grouping,” “analyzing,” “adjusting,” “adding,” “retrieving,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combinations of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times, or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component.

Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

1. A method comprising:
training, over a plurality of steps, a machine learning (ML) model to group files based on a hierarchy of characteristics, wherein at each of the plurality of steps, the ML model is trained to group files iteratively, and wherein at each iteration the ML model learns to group files based on a particular characteristic from the hierarchy of characteristics;
providing to a machine learning (ML) model, a set of files, wherein the ML model is configured to generate, based on the set of files, a feature vector database comprising a set of feature vectors, wherein each of the set of feature vectors corresponds to a particular file of the set of files and wherein the set of feature vectors is grouped based on the hierarchy of characteristics;
in response to receiving a query file to be compared to the set of files, processing the query file using the ML model to generate a query feature vector; and
querying, by a processing device, the feature vector database using the query feature vector to identify one or more of the set of files that are similar to the query file.

2. The method of claim 1, wherein the ML model is trained using training data comprising a plurality of training data batches, wherein each of the plurality of training data batches comprises a set of training files with a label for each characteristic in the hierarchy of characteristics, and wherein training the ML model comprises:
at each of the plurality of steps:
grouping, using the ML model, a respective training data batch iteratively based on the hierarchy of characteristics to generate an output for each iteration; and
for each iteration:
analyzing the output with a hierarchical contrastive learning (HCL) loss function to determine a loss value; and
adjusting one or more weights of the ML model based at least in part on the loss value.

3. The method of claim 2, wherein training the ML model further comprises:
for each iteration:
analyzing the output with a focal loss function to determine a second loss value; and
adding the loss value and the second loss value to generate a total loss value, wherein the one or more weights of the ML model are adjusted based on the total loss value.

4. The method of claim 1, wherein querying the feature vector database using the query feature vector comprises:
using a nearest neighbors algorithm to identify from the feature vector database, one or more of the set of feature vectors that are similar to the query feature vector.

5. The method of claim 4, further comprising:
for each of the identified one or more feature vectors, retrieving a file from the set of files corresponding to the identified feature vector to obtain the one or more of the set of files that are similar to the query file; and
providing the one or more of the set of files that are similar to the query file as a result set.

6. The method of claim 1, wherein the hierarchy of characteristics comprises: threat type, malware family, subtype, compiler, packer, and library.

7. The method of claim 1, wherein each of the set of files and the query file are portable executable files.

8. A system comprising:
a memory; and
a processing device operatively coupled to the memory, the processing device to:
train, over a plurality of steps, a machine learning (ML) model to group files based on a hierarchy of characteristics, wherein at each of the plurality of steps, the ML model is trained to group files iteratively, and wherein at each iteration the ML model learns to group files based on a particular characteristic from the hierarchy of characteristics;
provide to a machine learning (ML) model, a set of files, wherein the ML model is configured to generate, based on the set of files, a feature vector database comprising a set of feature vectors, wherein each of the set of feature vectors corresponds to a particular file of the set of files and wherein the set of feature vectors is grouped based on a hierarchy of characteristics;
in response to receiving a query file to be compared to the set of files, process the query file using the ML model to generate a query feature vector; and
query the feature vector database using the query feature vector to identify one or more of the set of files that are similar to the query file.

9. The system of claim 8, wherein the processing device trains the ML model using training data comprising a plurality of training data batches, wherein each of the plurality of training data batches comprises a set of training files with a label for each characteristic in the hierarchy of characteristics, and wherein to train the ML model, the processing device is to:
at each of the plurality of steps:
group, using the ML model, a respective training data batch iteratively based on the hierarchy of characteristics to generate an output for each iteration; and
for each iteration:
analyze the output with a hierarchical contrastive learning (HCL) loss function to determine a loss value; and
adjust one or more weights of the ML model based at least in part on the loss value.

10. The system of claim 9, wherein to train the ML model, the processing device is further to:
for each iteration:
analyze the output with a focal loss function to determine a second loss value; and
add the loss value and the second loss value to generate a total loss value, wherein the
one or more weights of the ML model are adjusted based on the total loss value.

11. The system of claim 8, wherein to query the feature vector database using the query feature vector, the processing device is to:
use a nearest neighbors algorithm to identify from the feature vector database, one or more of the set of feature vectors that are similar to the query feature vector.

12. The system of claim 11, wherein the processing device is further to:
for each of the identified one or more feature vectors, retrieve a file from the set of files corresponding to the identified feature vector to obtain the one or more of the set of files that are similar to the query file; and
provide the one or more of the set of files that are similar to the query file as a result set.

13. The system of claim 8, wherein the hierarchy of characteristics comprises: threat type, malware family, subtype, compiler, packer, and library.

14. The system of claim 8, wherein each of the set of files and the query file are portable executable files.

15. A non-transitory computer-readable medium having instructions stored thereon which, when executed by a processing device, cause the processing device to:
train, over a plurality of steps, a machine learning (ML) model to group files based on a hierarchy of characteristics, wherein at each of the plurality of steps, the ML model is trained to group files iteratively, and wherein at each iteration the ML model learns to group files based on a particular characteristic from the hierarchy of characteristics;
provide to a machine learning (ML) model, a set of files, wherein the ML model is configured to generate, based on the set of files, a feature vector database comprising a set of feature vectors, wherein each of the set of feature vectors corresponds to a particular file of the set of files and wherein the set of feature vectors is grouped based on a hierarchy of characteristics;
in response to receiving a query file to be compared to the set of files, process the query file using the ML model to generate a query feature vector; and
query, by the processing device, the feature vector database using the query feature vector to identify one or more of the set of files that are similar to the query file.

16. The non-transitory computer-readable medium of claim 15, wherein the processing device trains the ML model using training data comprising a plurality of training data batches, wherein each of the plurality of training data batches comprises a set of training files with a label for each characteristic in the hierarchy of characteristics, and wherein to train the ML model, the processing device is to:
at each of the plurality of steps:
group, using the ML model, a respective training data batch iteratively based on the hierarchy of characteristics to generate an output for each iteration; and
for each iteration:
analyze the output with a hierarchical contrastive learning (HCL) loss function to determine a loss value; and
adjust one or more weights of the ML model based at least in part on the loss value.

17. The non-transitory computer-readable medium of claim 16, wherein to train the ML model, the processing device is further to:
for each iteration:
analyze the output with a focal loss function to determine a second loss value; and
add the loss value and the second loss value to generate a total loss value, wherein the one or more weights of the ML model are adjusted based on the total loss value.

18. The non-transitory computer-readable medium of claim 15, wherein to query the feature vector database using the query feature vector, the processing device is to:
use a nearest neighbors algorithm to identify from the feature vector database, one or more of the set of feature vectors that are similar to the query feature vector.

19. The non-transitory computer-readable medium of claim 18, wherein the processing device is further to:
for each of the identified one or more feature vectors, retrieve a file from the set of files corresponding to the identified feature vector to obtain the one or more of the set of files that are similar to the query file; and
provide the one or more of the set of files that are similar to the query file as a result set.

20. The non-transitory computer-readable medium of claim 15, wherein the hierarchy of characteristics comprises: threat type, malware family, subtype, compiler, packer, and library.
